(19) United States
(12) Patent Application Publication
(10) Pub. No.: US 2002/0177417 A1
(43) Pub. Date: Nov. 28, 2002

(54) Transmit/receive switch for an RF transceiver

(75) Inventor: Hendrik Arend Visser, Milpitas, CA (US)

Correspondence Address: Philips Electronics, North America Corporation, 580 White Plains Road, Tarrytown, NY, 10591, US

(73) Assignee: KONINKLIJKE PHILIPS ELECTRONICS N.V.

(21) Appl. No.: 09/865,235

(22) Filed: May 25, 2001

(51) Int. Cl. H04B 1/44

(52) U.S. Cl. 455/83; 455/78

(57) ABSTRACT

A transceiver for radio frequency signals has a transmit branch and a receive branch that are coupled to an antenna feed point The receive branch has a network with an input node and an output node. The input node is coupled to the antenna feed point and the output node is coupled to a low noise amplifier in the receive branch. The network is configured such that in a transmit node of the transceiver, the input node is switched as an open circuit caused by switching the output node as a short circuit.

### BACKGROUND OF THE INVENTION

1. Field of the Invention

The invention relates to a transceiver for radio frequency signal, more particularly to respective switching of a receive branch or a transmit branch to an antenna Such a transceiver can be used in a wireless local area network or in any other suitable wireless system.

2. Description of the Related Art

Transceivers for wireless systems such as wireless LANs, cellular or cordless telephone systems are well known in the art In one type of trasceivers, a transmit branch and a receive branch are respectively switched to an antenna, when the transceiver is in a transmit mode or in a receive mode, respectively. Reception or transmission may be in the same band or in separate bands. For respective switching of the transmit branch or the receive branch to the antenna, in known transceivers, a first switch is provided between an output stage of a power amplifier comprised in the transmit branch and an antenna feed point, a second switch is provided between the antenna feed point and an input stage of a low noise amplifier comprised in the receive branch.

### SUMMARY OF THE INVENTION

It is an object of the invention to provide switching of a transmit branch in a transceiver to an antenna feed point that also under high voltage output signals delivered by a transmit power output stage causes no component break through or other problems.

To this end the transceiver comprises a transmit branch that is coupled to an antenna feed point, a receive branch comprising a first network with an output node and with an input node that is coupled to the antenna feed point, the first network being configured such that in a transmit mode of said transceiver said input node is switched as an open circuit by switching said output node as a short circuit.

The inventor had realized that although in principle prior art transmit/receive switching networks that comprise MOS devices such as NMOS devices could function without malfunctioning when high voltages at the output stage of the transmit power amplifier needed to be generated, that there might be circumstances under which such NMOS devices could still break through. One such circumstance could be breaking off of the antenna, causing, due to severe antenna impedance mismatch, a sharp voltage increase at the antenna feed point. The inventor further realized that although there might be solutions to such break through problems, for low cost applications such as home networks, it would be highly desirable to provide a solution that allows full integration of the transmit/receive antenna switch, with minimal use of external components. The invention provides such a solution, at least for the receive antenna switch, by creating an open circuit at the network side that is coupled to the antenna feed point, seen from the antenna feed point, when the transceiver is in transmit mode, such an open circuit being created through impedance transformation by a switch at the other side of the network without imposing any problems on the switch itself, even when using a non-ideal transformation network. Or, stated otherwise, impedance transformation as of the invention from a low voltage node to a high voltage node allows use of switching components such as NMOS devices at the output node of the network with low break through voltages. In this respect, the transmit output stage may generate a high voltage in the order of 5-10 volts typically causing no higher worst case voltage at the output node than in the order of 1 volt. Herewith, the antenna receive switch can be very easily integrated in an integrated circuit.

In an embodiment, the first network may be an LC-network. In another embodiment, the first network may be a ¼-Lamda transmission network.

In embodiments, in the transmit mode, the output node may be switched to a low or zero voltage by an NMOS device or a Reed relays coupled between the output node and ground.

In another embodiment, in the transmit mode, the output node may be switched to low or zero voltage by a transistor, e.g. a MOS device, that is coupled in a feedback path of a low noise amplifier in the receive branch. In such an embodiment, feedback prevents change of input voltage at an input of the low noise amplifier so that the input voltage is effectively kept to a zero voltage level while still the low noise amplifier can draw current. Herewith, effectively, the input of the low noise amplifier acts as a short circuit when the transceiver is in the transmit mode.

In an embodiment, a tank circuit that is coupled to a transmit power output transistor is directly coupled to the antenna feed point. In this embodiment, when the transceiver is in receive mode, the transmit power output transistor is simply switched off so that its output is high-ohmic. This might cause some losses, when the transceiver is in receive mode, but such losses are typically low, as shown by simulations, no more than in the order of 1 dB. This solution allows very easy integration of the full transmit/receive antenna switch in an integrated circuit. This is because the transmitter, the receiver and the transmit/receive antenna switch can be integrated using the same RF silicon process, such as a QUBIC3 process.

In another embodiment, the tank circuit is coupled to the antenna feed point by a MOS switch between the tank circuit and the antenna feed point. Also in this embodiment, the transmit power output transistor is switched off when the transceiver is in receive mode. Although in this embodiment the transmit antenna switch part is not so easy to integrate in an integrated circuit, reduced loss is obtained when the transceiver is in receive mode. This is because a different RF silicon process is needed to implement the transmit antenna switch part, to prevent break through, such as an RF GaAs process

### BRIEF DESCRIPTION OF THE DRAWING

FIG. 1 is a diagram of a transceiver according to the invention.

FIG. 2 is circuit diagram of an input stage of a low noise amplifier including a switch according to the invention

FIG. 3 is an embodiment of network of the invention.

FIG. 4 shows a transmit antenna switch part in a transmit/receive switch according to the invention.

Throughout the figures the same reference numerals are used for indicating the same elements.

### DESCRIPTION OF THE DETAILED EMBODIMENTS

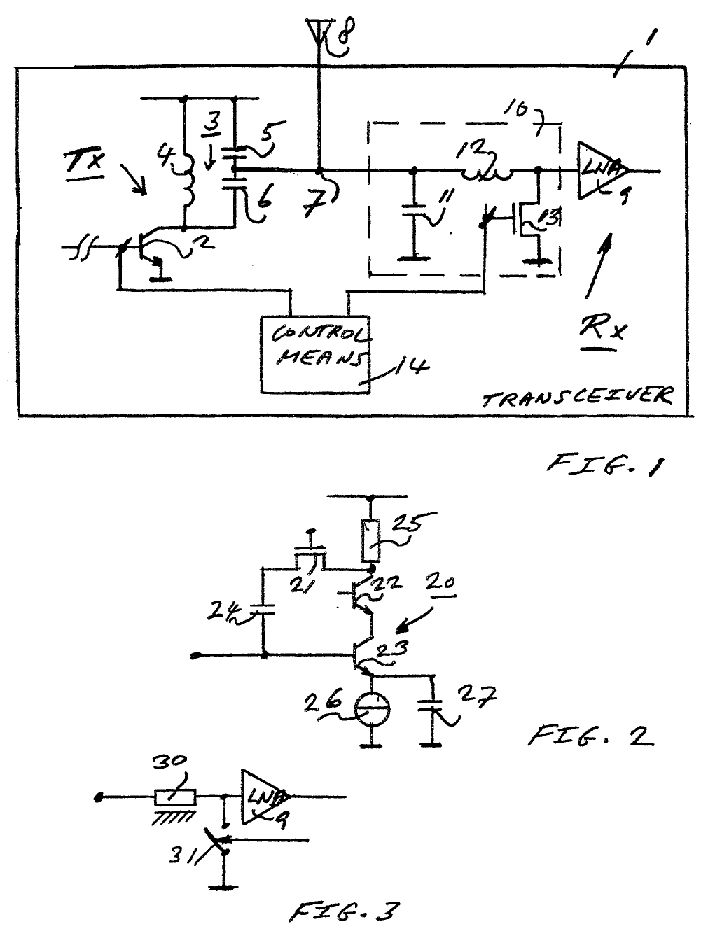

FIG. 1 is a diagram of a transceiver 1 according to the invention. Such a transceiver 1 may be part of an apparatus such as a wireless network apparatus, a cell phone, a cordless phone, a PDA, a PC with a wireless module, or the like. The transceiver 1 may also be included in a radio frequency transceiver module to be used in an apparatus or system, or a combination of devices. The transceiver 1 comprises a transmit branch Tx and a receive branch Rx. In transmit branch Tx, a transmit power transistor 2 is shown that is coupled to a transmit tank circuit 3 comprised of an inductor 4, a capacitor 5 and a capacitor 6. The tank circuit 3 is coupled to an antenna feed point 7 to which an antenna 8 is or can be connected. In receive branch Rx, a low noise amplifier (LNA) 9 is shown that is coupled to the antenna feed point 7 via a network 10. In the shown embodiment, network 10 comprises a capacitor 11 that is coupled between an input node of network 10 and ground, an inductor 12 between antenna feed point 7 and an output node of network 10, and an NMOS switch 13 between the output node and ground. Transceiver 1 further comprises control means 14 to control the transceiver 1 to adopt a transmit mode or a receive mode, respectively. In transmit mode, NMOS switch 13 switches the output node to ground, i.e., the output node is short-circuited, thereby, through network 10 that performs impedance transformation, causing the input node to become an open circuit. LC-network 10 has two purposes, first to isolate receive branch Rx from the antenna 8 by creating a short circuit at the output which is seen as an open circuit at the input, and second to transfer the antenna signal to an input of low noise amplifier 9 by opening the short at the output. The ratio of the LC can be used to match the antenna impedance, typically 50 Ohms, to the input impedance of LNA 9.

FIG. 2 is circuit diagram of an input stage 20 of a low noise amplifier including a switch 21 according to the invention. Input stage 20 comprises cascoded transistors 22 and 23 of which transistor 23 is an input transistor that is coupled to inductor 12 shown in FIG. 1, and of which transistor 22 is an output transistor. In this embodiment, through a feedback mechanism whereby transistor 21 closes a feedback path when transceiver 1 is in transmit mode, the input voltage of low noise amplifier input stage 20 is kept low, zero or close to zero, so that the input impedance of input stage 20 is low or zero. Herewith, effectively a short circuit situation is obtained Further shown in FIG. 2 are a DC-blocking capacitor 24, a load resistor 25, a current source 26, and a capacitor 27.

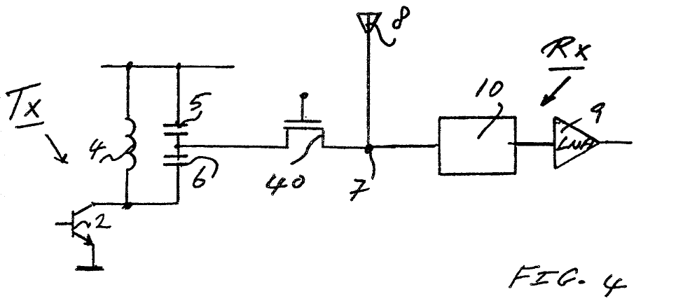

FIG. 3 is an embodiment of network 10 of the invention. In this embodiment, network 10 comprises a ¼-Lamda transmission line 30, embodied as a micro-strip line, and a switch 31 to ground. Switch 31 may be an RF Reed relays. Transmission line 30 is a bi-directional element that transforms a short circuit to an open circuit and vice versa. Network 10 has two purposes, first to isolate receive branch Rx from the antenna 8 by creating a short circuit at the output which is seen as an open circuit at the input, and second to transfer the antenna signal to an input of low noise amplifier 9 by opening the short at the output. The impedance of the micro-strip line can be used to match the antenna impedance, typically 50 Ohms, to the input impedance of LNA 9.

FIG. 4 shows a transmit antenna switch part in a transmit/receive switch according to the invention comprising an NMOS transmit switch 40. With transceiver 1 in receive mode with transistor 2 switched off, switch 40 is open thereby blocking reception energy to enter transmit branch Tx.

In view of the foregoing it will be evident to a person skilled in the art that various modifications may be made within the spirit and the scope of the invention as hereinafter defined by the appended claims and that the invention is thus not limited to the examples provided. The word “comprising” does not exclude the presence of other elements or steps than those listed in a claim.

What is claimed is:

1. A transceiver for radio frequency signals, said transceiver comprising:
a transmit branch that is coupled to an antenna feed point;
a receive branch comprising a first network with an output node and with an input node that is coupled to said antenna feed point, said first network being configured such that in a transmit mode of said transceiver said input node is switched as an open circuit by switching said output node as a short circuit.

2. A transceiver as claimed in claim 1, wherein said first network comprises a capacitor that is coupled between said input node and ground, an inductor that is coupled between said input node and said output node, and a first switch that is coupled between said output node and said ground.

3. A transceiver as claimed in claim 2, wherein said first switch is MOS transistor.

4. A transceiver as claimed in claim 1, wherein said receive branch comprises a low noise amplifier that is coupled to said output node, and said first network comprises a capacitor that is coupled between said input node and ground, an inductor that is coupled between said input node and said output node, and a second switch that is comprised in a feedback path of an input stage of said low noise amplifier.

5. A transceiver as claimed in claim 1, wherein said first network comprises a ¼-Lamda transmission line that is coupled between said input node and said output node, and a second switch that is coupled between said output node and ground.

6. A transceiver as claimed in claim 5, wherein said second switch is a Reed switch that is suitable to switch radio frequency signals.

7. A transceiver as claimed in claim 1, wherein said transmit branch comprises a tank circuit, and a power transistor for providing a transmit power signal to said tank circuit when said transceiver is in said transmit mode, said tank circuit being directly connected to said antenna feed point, and said transceiver being configured to switch off said power transistor when said transceiver is in a receive mode.

8. A transceiver as claimed in claim 1, wherein said transmit branch comprises a tank circuit, and a power transistor for providing a transmit power signal to said tank circuit when said transceiver is in said transmit mode, and a second switch that is coupled between said tank circuit and said antenna feed point, said transceiver being configured to open said second switch when said transceiver is in a receive mode.

9. A transceiver for radio frequency signals, said transceiver comprising:
a transmit branch that is coupled to an antenna feed point;
a receive branch comprising first network means with an output node and with an input node that is coupled to said antenna feed point, said first network means being configured such that in a transmit mode of said transceiver said input node is switched as an open circuit by switching said output node as a short circuit.

10. A transceiver as claimed in claim 9, wherein said first network means comprises capacitive means and inductive means, and first switch means for coupling said output node to ground when said transceiver is in a transmit mode, thereby causing, through said capacitive means and said inductive means, said input node to become an open circuit.

11. A radio frequency transceiver module for use in a transceiver, said radio frequency transceiver module comprising:
a transmit branch that is coupled to an antenna feed point;
a receive branch comprising first network means with an output node and with an input node that is coupled to said antenna feed point, said first network means being configured such that in a transmit mode of said radio frequency transceiver module said input node is switched as an open circuit by switching said output node as a short circuit.

12. A radio frequency transceiver module as claimed in claim 11, wherein said first network means comprises capacitive means and inductive means, and first switch means for coupling said output node to ground when said radio frequency transceiver module is in a transmit mode, thereby causing, through said capacitive means and said inductive means, said input node to become an open circuit.

13. A radio frequency transceiver module as claimed in claim 11, wherein said receive branch comprises low noise amplifier means coupled to said output node, and said first network means comprises capacitive means and inductive means, and second switch means for effectively coupling said output node to ground when said radio frequency transceiver module is in a transmit mode, thereby causing, through said capacitive means and said inductive means, said input node to become an open circuit, said second switch means being comprised in a feedback path of an input stage of said low noise amplifier means.

14. A radio frequency transceiver module as claimed in claim 11, wherein said first network means comprises ¼-Lamda transmission line means, and second switch means for coupling said output node to ground when said radio frequency transceiver module is in a transmit mode, thereby causing, through ¼-Lamda transmission line means, said input node to become an open circuit.

15. An apparatus with a transceiver for radio frequency signals, said transceiver comprising:
a transmit branch that is coupled to an antenna feed point;
a receive branch comprising a first network with an output node and with an input node that is coupled to said antenna feed point, said first network being configured such that in a transmit mode of said transceiver said input node is switched as an open circuit by switching said output node as a short circuit.

16. An apparatus as claimed in claim 15, wherein said first network comprises a capacitor that is coupled between said input node and ground, an inductor that is coupled between said input node and said output node, and a first switch that is coupled between output node and said ground.

17. An apparatus as claimed in claim 15, wherein said receive branch comprises a low noise amplifier that is coupled to said output node, and said first network comprises a capacitor that is coupled between said input node and ground, an inductor that is coupled between said input node and said output node, and a second switch that is comprised in a feedback path of an input stage of said low noise amplifier.

18. An apparatus as claimed in claim 15, wherein said first network comprises a ¼-Lamda transmission line that is coupled between said input node and said output node, a second switch that is coupled between said output node and ground.
